(19) United States
(12) Patent Application Publication
(10) Pub. No.: US 2015/0058057 A1
(43) Pub. Date: Feb. 26, 2015

(54) SYSTEMS AND METHODS FOR SCHEDULING A MEETING

(71) Applicant: Facebook, Inc., Menlo Park, CA (US)

(72) Inventors: John David EGAN, San Francisco, CA (US); Scott MacVICAR, San Francisco, CA (US); Eric SUMNER, Newark, CA (US)

(21) Appl. No.: 13/973,792

(22) Filed: Aug. 22, 2013

(51) Int. Cl. G06Q 10/10

(52) U.S. Cl. CPC G06Q 10/1095
USPC 705/7.19

(57) ABSTRACT

Systems, computer implemented methods, and computer readable media select potential meeting times and meeting locations. Meeting parameters are generated for a meeting request. Scores for each of a plurality of meeting times are generated based on the meeting parameters. Scores for each of a plurality of meeting locations are generated based on the meeting parameters. One or more potential meeting time and meeting location pairs are selected based on the scores for each of the plurality of meeting times and the scores for each of the plurality of meeting locations.

### FIELD OF THE INVENTION

The present disclosure relates to the field of meeting management. More particularly, the present disclosure provides techniques related to scheduling a meeting.

### BACKGROUND

Calendaring systems may provide different functionality for individual and organizational use. For example, some calendaring systems may allow users to record and organize scheduled events. As another example, some calendaring systems may allow users to share their respective calendars with each other. In this regard, a user may be able to selectively view or otherwise access another person's calendar to see when the person is available or has scheduled events, such as appointments, meetings, etc. Such access may facilitate meeting planning with multiple users.

Calendaring systems may be especially useful for organizations. Organizations can include businesses, schools, non-profits, and other entities. An organization often requires meetings among its members to conduct important business or otherwise advance its objectives through collaboration. However, despite the use of calendaring systems, the ability to schedule and conduct meetings is often complicated by the size and complexity of the organization.

### SUMMARY

To provide potential meeting times and location in response to a meeting request, embodiments of the present disclosure include systems, computer implemented methods, and computer storage media to select potential meeting times and meeting locations. Meeting parameters are generated for a meeting request. Scores for each of a plurality of meeting times are generated based on the meeting parameters. Scores for each of a plurality of meeting locations are generated based on the meeting parameters. One or more potential meeting time and meeting location pairs are selected based on the scores for each of the plurality of meeting times and the scores for each of the plurality of meeting locations.

In an embodiment, at least one potential meeting time and meeting location pair is selected for each campus of a plurality of campuses associated with the meeting request. In an embodiment, the plurality of campuses is in different time zones.

In an embodiment, at least one of the scores for each of the plurality of meeting times and the scores for each of the plurality of meeting locations is based on point deductions associated with penalties.

In an embodiment, the generating of scores for each of the plurality of meeting times is based at least in part on attendee availability or status. In an embodiment, the generating of scores for each of the plurality of meeting times is based at least in part on optimization of schedules of attendees. In an embodiment, the generating of scores for each of the plurality of meeting times is based at least in part on whether the meeting times fall on a weekend. In an embodiment, the generating of scores for each of the plurality of meeting times is based at least in part on whether the meeting times fall on a company official holiday in the country where the attendee (e.g., employee of the company) is located. In an embodiment, the generating of scores for each of the plurality of meeting times is based at least in part on whether the meeting times fall within a predetermined time range within a work day.

In an embodiment, the generating of scores for each of the plurality of meeting locations is based at least in part on a distance between an attendee location and a meeting location. In an embodiment, the generating of scores for each of the plurality of meeting locations is based at least in part on a room size. In an embodiment, the generating of scores for each of the plurality of meeting locations is based at least in part on equipment availability at a meeting location. In an embodiment, the generating of scores for each of the plurality of meeting locations is based at least in part on video conferencing availability at a meeting location.

In an embodiment, the meeting parameters comprise a length of time for a meeting. In an embodiment, the meeting parameters comprise information about required attendees and optional attendees.

In an embodiment, a time period and a time interval are determined to identify a meeting time. The generating of scores for each of the plurality of meeting times is performed for all time intervals within the time period.

In an embodiment, the one or more potential meeting times and meeting locations are communicated to a user device associated with a meeting organizer. In an embodiment, an indication of a selection of a final meeting time and meeting location by the meeting organizer is received. A scheduling event is initiated for the final meeting time and meeting location.

In an embodiment, schedule data is unavailable for at least one attendee associated with the meeting request.

Many other features and embodiments of the invention will be apparent from the accompanying drawings and from the following detailed description.

### BRIEF DESCRIPTION OF THE DRAWINGS

FIG. 1 illustrates an example meeting scheduling system, according to an embodiment of the present disclosure.

FIG. 2 illustrates an example scheduling module, according to an embodiment of the present disclosure.

FIG. 3 illustrates an example process for selecting one or more meeting times and locations in response to a meeting request, according to an embodiment of the present disclosure.

FIG. 4 illustrates an example process for selecting one or more meeting times and locations in response to a meeting request, according to an embodiment of the present disclosure.

FIG. 5 illustrates a user interface for a meeting request, according to an embodiment of the present disclosure.

FIG. 6 illustrates a user interface displaying various potential meeting times that are selected and communicated to a meeting organizer in response to a meeting request, according to an embodiment of the present disclosure.

FIG. 7 illustrates a user interface showing potential meeting locations for a specific meeting time chosen by a meeting organizer, according to an embodiment of the present disclosure.

FIG. 8 is a network diagram of an example system for selecting meeting times and locations in response to a meeting request, according to an embodiment of the present disclosure.

FIG. 9 illustrates an example of a computer system that may be used to implement one or more of the embodiments described herein, according to an embodiment of the present disclosure.

The figures depict various embodiments of the present invention for purposes of illustration only, wherein the figures use like reference numerals to identify like elements. One skilled in the art will readily recognize from the following discussion that alternative embodiments of the structures and methods illustrated in the figures may be employed without departing from the principles of the invention described herein.

### DETAILED DESCRIPTION

### Selection of Meeting Times and Locations

A wide variety of groups may implement a calendaring system, such as companies, hospitals, colleges, organizations, etc. The size and complexity of these groups may vary. For example, companies implementing calendaring systems may range from small companies having a single office or building to large companies including multiple buildings within multiple campuses, which are located in multiple time zones. While parts of the present disclosure may be described with reference to a particular group and its members, such as a company and its employees, it should be appreciated that the underlying concepts may be applicable to other types of groups and its members.

Even though users of a calendaring system (e.g., members of a group) may be able to view other users' calendars, determining a suitable meeting time for a desired meeting may be difficult or cumbersome. To schedule a meeting, the meeting organizer may evaluate the calendars of the potential attendees (invitees) and attempt to ascertain a meeting time for the meeting. After the meeting organizer schedules a meeting, an invite request may be sent to the attendees of the meeting. Attendees may then accept or decline the meeting as desired. If an attendee accepts the invite, then the meeting is input into her calendar. If the attendee declines the invite, then the meeting is not input into her calendar.

It may be difficult for a meeting organizer to select a meeting time that works well for a desired meeting. For example, a large number of attendees may make it difficult to identify a meeting time that works well for the large number of attendees. Furthermore, the statuses of attendees (e.g., out of office, working remotely or at another office location, etc.) may complicate the meeting organizer's determination of a meeting time that works well. For larger groups, such as companies having multiple campuses in geographic locations remote from one another, taking into consideration attendees in different time zones may further complicate the determination of a meeting time.

Furthermore, a meeting organizer may wish to select a meeting location, yet may have little or no familiarity with possible meeting locations within one or more buildings and campuses of the organization. Moreover, the larger the building and campus, the more likely the meeting organizer may not be familiar with many of the possible meeting locations within the organization or the location of each of the potential attendees of the meeting. This makes it difficult for a meeting organizer to determine a meeting location that is optimal. For example, multiple attendees may be spread out over multiple buildings in a campus, or may be located in different campuses in different time zones. Some meeting locations may be inefficiently or inconveniently located for the attendees of the meeting. For example, a meeting location may cause many attendees to walk or otherwise travel greater distances to a further meeting location. The meeting organizer may wish to schedule a meeting location that minimizes or limits the distance that the attendees must travel to arrive at the meeting location. Furthermore, the meeting organizer may desire or require a meeting location with specific attributes—e.g., having enough seats to accommodate the number of attendees, having a telephone or television, having video conferencing capability, etc.

When scheduling a meeting with one or more attendees, the meeting organizer may not have the time, resources, or desire to determine a meeting time and location that is preferable. Often times, the meeting organizer may simply wish to schedule any upcoming meeting time and location (or even the next possible meeting time and location) that is suitable for all or most attendees, or for the requirements of the meeting location.

The present disclosure provides systems, methods, and computer storage mediums that select potential meeting times and locations in response to a meeting request by a meeting organizer. In an embodiment, meeting parameters are generated for a meeting request. Scores for each of a plurality of meeting times are generated based on the meeting parameters. Scores for each of a plurality of meeting locations are generated based on the meeting parameters. One or more potential meeting time and meeting location pairs are selected based on the scores for each of the plurality of meeting times and the scores for each of the plurality of meeting locations.

The scores may be generated based on scoring rules in a manner so that favorable meeting times generate better (e.g., higher) scores than unfavorable meeting times. The scoring rules may be based on a variety of factors that relate to the meeting time—e.g., attendee availability, attendee status, time or day that the meeting occurs, etc. Scoring rules may also be based on factors that relate to meeting location—e.g., room size, equipment at the meeting location (e.g., projector, telephone, television), capability of the meeting location (e.g., video conferencing enabled, accommodation for disabilities, etc.). Meeting times and locations may then be ranked or otherwise sorted by score so that the most favorable meeting times and locations may be determined and selected for communication to the meeting organizer.

In an embodiment, the meeting organizer and one or more attendees of a meeting request may be part of a social networking system. The social networking system may include, or work in conjunction with, a calendaring system that enables one or more users of the social networking system to share calendars, and to schedule meetings according to one or more embodiments described herein.

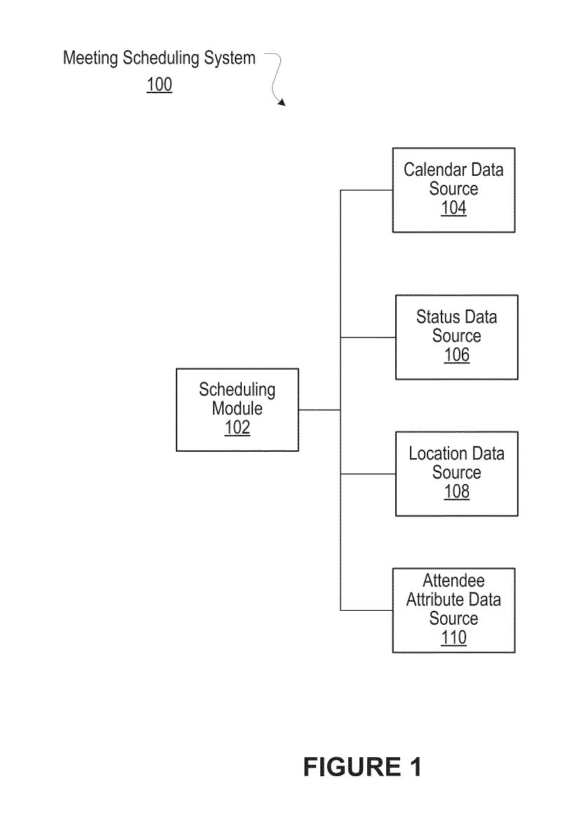

FIG. 1 illustrates an example meeting scheduling system, according to an embodiment of the present disclosure. A meeting scheduling system 100 is shown including a scheduling module 102 communicatively coupled to a calendar data source 104, a status data source 106, a location data source 108, and an attendee attribute data source 110. The depicted components in this figure and the following figures are exemplary only, and may be variously replaced by, combined with, or integrated into other similar components.

The scheduling module 102 may be implemented by one or more computers, such as servers within a network system. Each of the data sources (e.g., the calendar data source 104, the status data source 106, the location data source 108, and the attendee attribute data source 110) may be local or remote to the scheduling module 102. For instance, each of the data sources may be on the same server as the scheduling module 102, or on a remote server communicatively coupled to scheduling module 102 via a network (e.g., LAN, WAN, internet, etc.).

The meeting scheduling system 100 may also be communicatively coupled to one or more user devices (not shown in FIG. 1). The user devices may include, for example, one or more computing devices (e.g., conventional computer, laptop, smart-phone, tablet, personal digital assistant (PDA), mobile telephone, etc.) that can receive input from a user and transmit and receive data to and from the meeting scheduling system 100 (e.g., via the network).

The user devices may, for example, be communicatively coupled to the scheduling module 102 and allow a meeting organizer to initiate a meeting request with or for the scheduling module 102. The user devices may be remote to the scheduling module 102 and communicatively coupled to the scheduling module 102 via the network. Additional details of an example user device are provided herein.

In an embodiment, the meeting organizer may indicate one or more meeting parameters with the meeting request. The meeting parameters can be of any type. For example, the meeting organizer may include the potential attendees of the meeting and the length of the meeting. As another example, the meeting organizer may specify the duration by which the meeting should take place. As yet another example, the meeting organizer may identify both required and optional attendees in the meeting request. As yet still another example, the meeting organizer may also include additional meeting parameters within the meeting request, such as a title or a description of the meeting. As yet a further example, meeting parameters may include the number of campuses involved for a proposed meeting, as well as consideration of their time zones. For example, campus and time zone information for a meeting location or an attendee may be obtained from one or more data sources (e.g., as discussed herein). Other meeting parameters may also be specified. The scheduling module 102 receives the meeting request and uses one or more of the meeting parameters to perform a search of meeting times and meeting locations for the meeting request. The search may include scoring a plurality of meeting times and a plurality of meeting locations based on various predetermined scoring rules or policies.

The scheduling module 102 may access one or more of the data sources (e.g., the calendar data source 104, the status data source 106, the location data source 108, and the attendee attribute data source 110) to obtain information for scoring various meeting times and meeting locations. The scheduling module 102 may use the scores to select one or more potential meeting times and potential meeting locations in response to the meeting request. The meeting organizer may be presented with the selected potential meeting times and locations on a user device for subsequent selection of a final meeting time and location.

The calendar data source 104 may include calendar information for one or more potential attendees of a meeting request. The scheduling module 102 may access the calendar data source 104 to obtain the calendar information for the one or more attendees. The calendar information may provide scheduling information for attendees, such as whether the attendee is available (or free) or unavailable (or busy) for various meeting times.

The calendar data source 104 may be implemented by, or include, for example, a calendaring program that allows the sharing of calendar information among users of a group. In an embodiment, a calendaring program may include Microsoft Outlook with Exchange Server or other calendar tool, for instance.

The status data source 106 may include information for the status of one or more potential attendees of a meeting request. The scheduling module 102 may access the status data source 106 to obtain the status information for the attendees. The status data source 106 may include, for example, information regarding one or more of the following: whether an attendee is out of the office or otherwise not working (e.g., paid time off), whether the attendee is traveling, and whether the attendee is working remotely from a customary office location (e.g., at home or within another office location). In an embodiment, the status data source 106 may include information as to where a user last logged in to a computer system of an organization. In this way, for example, users, such as new employees without an assigned desk location, may be temporarily assigned for the purposes of scheduling to the last location where they logged in.

The location data source 108 may include information relevant to meeting locations (e.g., meeting rooms). The scheduling module 102 may access the location data source 108 to obtain information relevant to various meeting locations. The location data source 108 may include, for example, information about one or more of the following: relevant geographic information about meeting rooms (e.g., at which campus, building, and floor a meeting room is located, etc.); the number of rooms per floor of a building; the capacity of a room (e.g., number of seats, square footage, etc.); the equipment of a room (e.g., telephone, television, projector, etc.); the capability of the room (e.g., video conferencing (VC) enabled, accommodation for disabilities, etc.); whether the room may be reserved; time zones for meeting rooms or campuses; etc. The information about the location of the room may also include how the buildings are connected. Connections among buildings may be used to determine the traveling (e.g., walking, biking, etc.) path and distance from an attendee's location (e.g., desk) to the meeting room.

The attendee attribute data source 110 may include information about attendee attributes. The scheduling module 102 may access the attendee attribute data source 110 to obtain the attribute information. The attendee attribute data source 110 may include, for example, general profile information for the attendee, such as name, profile picture, contact information, etc. In an embodiment, the attendee attribute data source 110 may include an employee database for employees of a company, and contain employee information about attendees, such as job title of attendees, office or desk location of attendees (e.g., which office number, floor, building, campus, applicable time zone, etc.), etc.

In an embodiment, the attendee attribute data source 110 includes information about attendee preferences. Example preferences may include, but are not limited to: preference for meeting locations, days, or times; undesirable meeting locations, days, or times; whether an attendee prefers to meet near other attendees; whether traveling further distances to a meeting room is important; preference for attributes of a meeting location (e.g., room size, room equipment, room capability, etc.); etc. The preferences may not only apply to the attendees, but also to the meeting organizer (both as an attendee and as the meeting organizer). The preferences of the meeting organizer may include, for example, a preference to schedule or avoid meetings on particular days or times; a preference to set meeting locations closer to other attendees rather than the meeting organizer, a preference to set meeting locations closer to attendees having the highest titles, attendees having the most difficulty in traveling to a meeting location, attendees that are customers of the meeting organizer, etc.

The preferences may be based on user settings, which the user may set and update accordingly over time. The preferences may also be based on historical patterns for the attendees or the meeting organizer—e.g., whether an attendee tends to miss or attend meetings on specific days or times in the day; whether a meeting organizer tends to schedule or avoid scheduling meetings during specific days or times in the day; whether a meeting organizer tends to require specific room attributes (e.g., video conferencing capability); etc. Historical patterns may be identified and stored within the attendee attribute data source 110 for subsequent access by the scheduling module 102.

In an embodiment, the scheduling module 102 may account for attendees that do not have availability or location data available (e.g., invitees outside the internal organization or company). For example, the scheduling module 102 may disregard or otherwise not consider the attendees without availability or location data available. The scheduling module 102 may also send one or more potential options to the attendees without availability or location data available and allow them to accept or reject a potential meeting time or location. It should be appreciated that the examples provided for each of the data sources are not intended to be limiting, and that the examples may be implemented alone or in combination. Furthermore, each of the data sources may include other information in addition to the information described herein.

It should also be appreciated that the data sources provided are exemplary, and that the features and functionality of more than one data source may be combined into a single data source in other embodiments. For example, the features and function of the status data source 106 may be provided by the calendar data source 104. Furthermore, the features and functionality of a single data source may be divided and implemented by more than one data source in other embodiments. Additional data sources may also be implemented and used in the determination of meeting times and meeting locations in other embodiments.

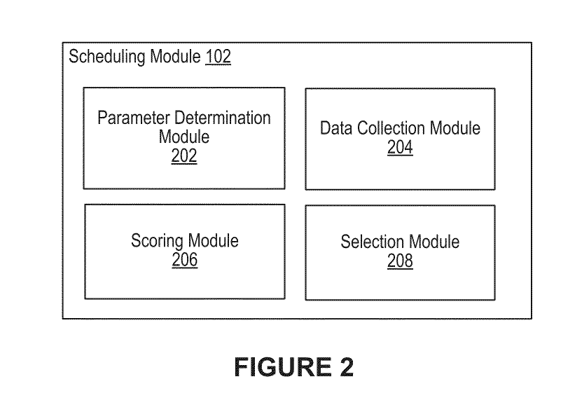

FIG. 2 illustrates an example scheduling module 102 of FIG. 1, according to an embodiment of the present disclosure. The scheduling module 102 includes a parameter determination module 202, a data collection module 204, a scoring module 206, and a selection module 208.

The parameter determination module 202 determines the meeting parameters of a meeting request. The parameter determination module 202 may receive one or more meeting parameters indicated by a meeting organizer when requesting a meeting. One or more of the meeting parameters may be used by the scheduling module 102 to search for potential meeting times and locations in response to the meeting request. The searching may include generating scores for meeting times and meeting locations, and selecting potential meeting times and meeting locations based on the scores so that optimal meeting times and locations are selected.

The parameter determination module 202 may also determine a time period over which meeting searches may be performed in response to the meeting request. A time period may represent a duration by which the meeting to be scheduled should occur. Meeting times and meeting locations within the time period will be scored (e.g., by the scheduling module 102). Example time periods may include, but are not limited to, the current work week, current week, next 2 weeks, next 3 days, or any other time period.

The parameter determination module 202 may also determine the time interval within the time period for which meeting searches may be performed. The time interval may represent a period for selecting possible start times for a proposed meeting. For example, with respect to a 30 minute meeting, a 15 minute interval signifies that the scheduling module 100 will look for meeting times to begin at 8 am, 8:15 am, 8:30 am, and so on for the time period. The meeting times and meeting locations at every time interval within the time period are scored. Example time intervals may include, but are not limited to, 15 minute intervals, 30 minute intervals, or any other time interval.

The time period and the time interval may be predetermined values (e.g., default values or selectable values). In another embodiment, one or both of the time period and the time interval may be indicated by the meeting organizer as a meeting parameter within the meeting request. In an embodiment, the meeting request may also indicate a specific meeting date as a meeting parameter. In such case, for example, a meeting search is performed for the specific date indicated.

The data collection module 204 accesses various data sources (e.g., the calendar data source 104, the status data source 106, the location data source 108, and the attendee attribute data source 110) to obtain information for scoring various meeting times and meeting locations.

The scoring module 206 may score meeting times and meeting locations based on the meeting parameters provided by the parameter determination module 202 and the information obtained by the various data sources (e.g., the calendar data source 104, the status data source 106, the location data source 108, and the attendee attribute data source 110).

The scoring module 206 may use predetermined scoring rules for scoring meeting times and locations. The scoring rules may provide for accumulation of points (e.g., awarded points for desirable aspects of a meeting time or location), deduction of points (e.g., penalties for undesirable aspects of a meeting time or location), weights (e.g., to assign greater importance to particular aspects of a meeting time or location), etc. The scoring rules may vary in different embodiments. In an embodiment, the scoring is based on penalizing undesirable aspects of a meeting time or location and rewarding desirable aspects of a meeting time or location. In an embodiment, a score may initially have a preselected value (e.g., zero or another predetermined integer) and then the preselected value may change (i.e., decreased or increased) according to application of the scoring rules.

The following provides example scoring rules that may be implemented alone or in combination. Other scoring rules may also be implemented instead of, or in addition to, the examples provided. For example, the events or conditions that may increase or decrease a score may include events or conditions in addition to those described herein. As another example, the amounts of an increase or decrease (e.g., in points) in a score may also include amounts in addition to those described herein.

A scoring rule may be based on attendee availability (e.g., as determined by information from the attendees' calendars obtained from the calendar data source 104). For example, each unavailable attendee for a proposed meeting time (e.g., attendees with conflicting appointments) may factor against having the meeting at the proposed meeting time. In this instance, the scoring rule may generate a penalty.

A scoring rule may be based on attendee status (e.g., as determined by information from the status data source 106). For example, each attendee with a status that makes the attendee unavailable for a proposed meeting time or location (e.g., PTO, vacation, etc.) may factor against having the meeting at the proposed meeting time or location. In this instance, the scoring rule may generate a penalty.

A scoring rule may be based on the organization of attendee schedules (e.g., as determined by information from the attendees' calendars obtained from the calendar data source 104). For example, each attendee schedule that the meeting would organize in an inefficient or undesirable manner, may factor against having the meeting at the proposed meeting time or location. In this instance, the scoring rule may generate a penalty. For example, if the scheduling of a proposed meeting would generate breaks within attendees' schedules (e.g., before or after the meeting), such scheduling may be viewed as an inefficient use of time.

A scoring rule may be based on location relevant attributes (e.g., as determined by information from the location data source 108). Location relevant attributes may include campus specific attributes that apply to attendees within a campus. Whether attendees are associated with different campuses (e.g., in different time zones, countries, etc.), and how many attendees are associated with those campuses, may be taken into consideration. For example, meetings occurring on weekends, holidays (e.g., a company official holiday for the country in which a campus is located), or at predetermined times (e.g., too early in the day or too late at night) would impact all attendees within a campus and would factor against having such a meeting. In this instance, the scoring rule may generate a penalty.

Location relevant attributes may include meeting location attributes, such as a meeting room's location with respect to attendees (e.g., the distance an attendee would travel to the meeting location); room size; room equipment or capability (projector, television, telephone, video conferencing capability, etc.); etc. For example, a meeting room that requires greater walking distances by attendees, or that is too small for the number of attendees, or that lacks required room capability would factor against having the meeting at the room. In this instance, the scoring rule may generate a penalty. In some instances, the room may be eliminated as a possible choice.

A scoring rule may be based on preferences for attendees or for the meeting organizer (e.g., as determined by information obtained from the attribute data source 108). For example, a proposed meeting time or location that is inconsistent with preferences may be scored accordingly to factor against having the meeting at that time or room. In this instance, the scoring rule may generate a penalty. In some instances, the preference may eliminate a meeting time or location as a possible choice.

A scoring rule may be based on whether an attendee is required or optional (e.g., as determined by the meeting parameters of the meeting request). For example, optional attendees may be weighted or otherwise scored in a manner that reflects their lesser importance compared to required attendees. For instance, a penalty incurred for an optional attendee being unavailable for a meeting may be smaller than the penalty incurred for a required attendee being unavailable.

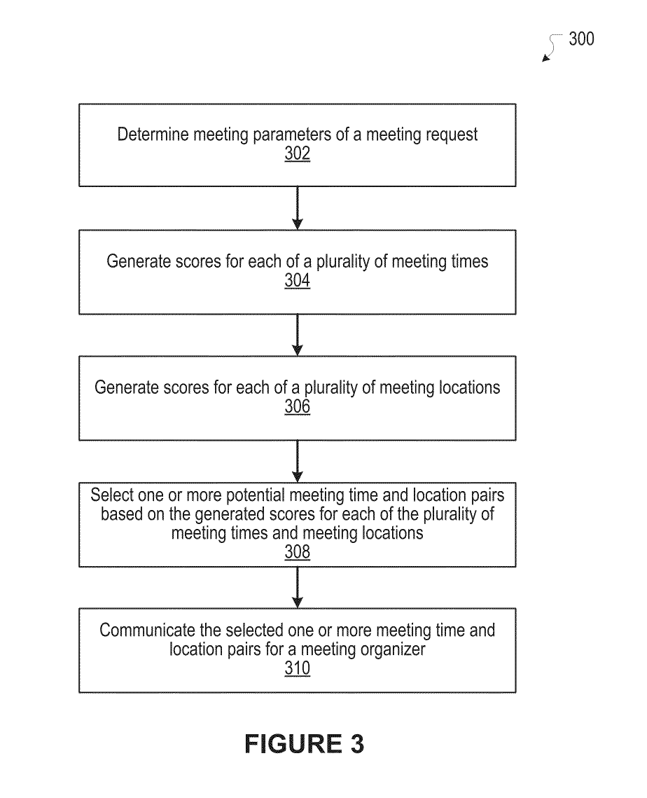

FIG. 3 illustrates an example process 300 for selecting one or more potential meeting times and meeting locations in response to a meeting request, according to an embodiment of the present disclosure. At block 302, the meeting parameters of a meeting request are determined—e.g., by the parameter determination module 202 of FIG. 2. The meeting parameters may include meeting parameters identified within the meeting request by the meeting organizer or any predetermined meeting parameters (e.g., time interval and time period for meeting searches).

At blocks 304 and 306, scores are generated for each of a plurality of meeting times and meeting locations, respectively. For example, the scoring module 206 in FIG. 2 may generate the scores for the meeting times and meeting locations. The scoring module 206 may use one or more scoring rules, such as described herein, to determine scores for various meeting times and meeting locations. Scores for meeting times and meeting locations may be generated using one or more meeting parameters (e.g., from the parameter determination module 202 of FIG. 2) and information obtained from any of the data sources (e.g., the calendar data source 104, the status data source 106, the location data source 108, and the attendee attribute data source 110 of FIG. 2).

In an embodiment, the scoring module 206 may generate a cumulative score for specific meeting time and meeting location pairs. In this way, each meeting time and meeting location pair may be compared with one another and ranked (or sorted) by score. In an embodiment, favorable meeting times may be specified to be more important than favorable meeting locations. Accordingly, the scoring of the meeting locations may be designed to weigh less than the scoring of the meeting times—e.g., by assessing relatively smaller penalties for undesirable meeting locations than for undesirable meeting times. In an embodiment, the meeting times may be scored and ranked first to rank the best meeting times, and then subsequently the meeting locations may be scored for only a predetermined number of the highest scoring meeting times.

In an embodiment, the scoring module 206 may generate the scores based on a predetermined time period and time interval for the meeting search (e.g., as determined by the parameter determination module 202 of FIG. 2). In an embodiment, the scoring module 206 generates scores based on the scoring rules for meeting times and locations for every meeting at every interval within the time range. For instance, for every interval, a score for each meeting time and a score for each meeting location of a pair will be combined for a cumulative score for that interval.

At block 308, one or more potential meeting time and location pairs are selected based on the scores generated in blocks 304 and 306. For example, the potential meeting times and locations may be selected by the selection module 208 of FIG. 2. In an embodiment, the selection module 208 selects a predetermined number of meeting time and location pairs (e.g., top pair, top two pairs, top five pairs, top 10 pairs, etc.) based on the generated scores to in response to the meeting request from the meeting organizer. In an embodiment, the highest ranked meeting time and location pairs are selected as potential meeting times and locations for the meeting request.

At block 310, the selected meeting times and locations are communicated for the meeting organizer. For example, the selection module 208 of FIG. 2 may communicate the selected meeting time and location pairs to the appropriate client device associated with the meeting organizer. In this way, the meeting organizer may select a final meeting time and location pair. The selection module 208 may receive an indication of the selection of a final meeting time and location pair by the meeting organizer via the client device, and accordingly initiate a scheduling event for the final meeting time and location. The scheduling event may include scheduling the meeting by, for example, sending calendar invites to attendees associated with the meeting request.

In another embodiment, the selection module 208 automatically selects a meeting time and location (e.g., the highest ranked meeting time and location) and uses it as the final meeting time and location for the meeting request. In some instances, the selection module 208 may request user confirmation or approval before initiating a scheduling event for the automatically selected meeting time and location.

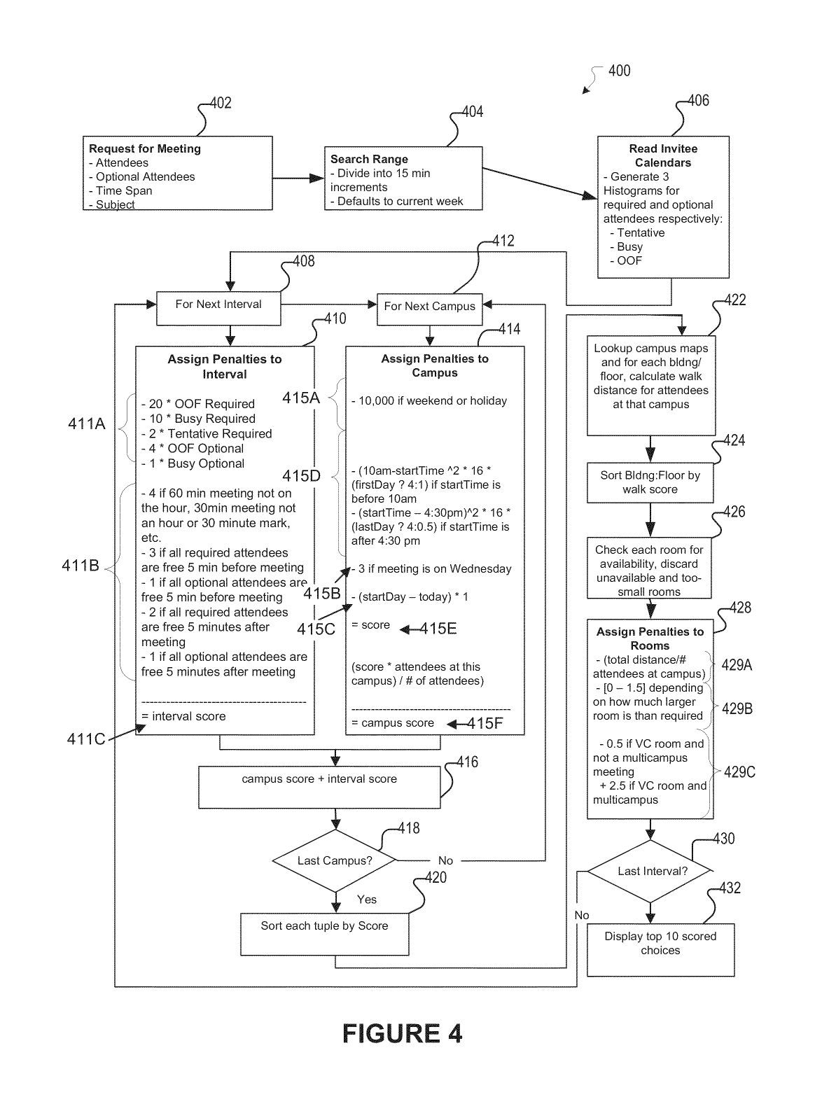

FIG. 4 illustrates an example process 400 for selecting one or more potential meeting times and locations in response to a meeting request, according to an embodiment of the present disclosure. At block 402, a meeting request is received that includes one or more meeting parameters (e.g., by the parameter determination module of FIG. 2). For example, the meeting parameters may include the attendees for the meeting (e.g., required and optional attendees), the length of the meeting being requested (e.g., 30 minutes, one hour, two hours, or other length of time), and the subject of the meeting.

At block 404, a time interval and a time period for the meeting search is determined (e.g., by the parameter determination module 202 of FIG. 2). For example, the time interval may be 15 minutes and the time period may be the current week.

At block 406, calendar information for each attendee is obtained (e.g., by the data collection module 204 of FIG. 2). The calendar information may include the attendees' availability (e.g., from the calendar data source 104 of FIG. 1) and attendees' statuses (e.g., from the status data source 106 of FIG. 1). In an embodiment, histograms for required and optional attendees may be generated based on availability or status considerations, such a tentative, busy, or out of office.

At block 408, a meeting time which is to be scored according to various scoring rules is chosen for the instant interval. It is noted the scoring will be applied to all proposed meetings for every time interval within the time period, as represented by the arrow going from block 430 back to block 408.

In the embodiment shown, the scores are in the form of penalties (or point deductions). A greater penalty (greater negative points) indicates a less favorable meeting time. It should be appreciated that the scoring rules are exemplary and are not intended to be limiting. Other scoring rules may be implemented in other embodiments. Furthermore, the type of scoring (e.g., penalties, awards, equations, weightings, or combination thereof) may vary in different embodiments.

At block 410, scoring rules relevant to the attendees' schedule (e.g., availability, status, and organization of the schedule) are applied. For example, the instant proposed meeting time is scored based on scoring rules 411A, 411B. Scoring rules 411A are based on attendee availability and status, and may include for example: for each required attendee that is out of office (OOF), a penalty of negative 20 points is assessed; for each optional attendee that is out of office (OOF), a penalty of negative 4 points is assessed; for each required attendee that is busy, a penalty of negative 10 points is assessed; for each optional attendee that is busy, a penalty of negative 1 point is assessed; and for each required attendee that is tentatively busy, a penalty of negative 2 points is assessed. As shown, the required attendees are more heavily weighted (i.e., have greater penalties) than the optional attendees.

Scoring rules 411B are scoring rules based on the effect of a meeting time on the attendees' schedules. For example, if a meeting time does not fall on a half hour or hour mark, then a break in attendees' schedules is likely and a negative 4 point penalty is assessed; if all required attendees are free 5 minutes before a meeting time, then a negative 3 point penalty is assessed; if all optional attendees are free 5 minutes before a meeting time, then a negative 1 point penalty is assessed; if all required attendees are free 5 minutes after a meeting time, then a negative 2 point penalty is assessed; and if all optional attendees are free 5 minutes after a meeting time, then a negative 1 point penalty is assessed. A cumulative score 411C is generated for the results of all the scoring rules in block 410 for the instant meeting time by adding all the penalty scores for scoring rules 411A and 411B.

Scores are also generated for the instant meeting according to campus specific scoring rules, as represented by blocks 412 and 414. Because more than one campus may apply to the instant meeting if, for example, attendees from different campuses are on the meeting request, a score will be generated for each campus.

At block 412, a proposed instant campus is selected for the proposed instant meeting time. At block 414, scores are generated for the instant meeting time according to one or more campus specific scoring rules. In the embodiment shown, campus specific scoring rules 415A, 415B, 415C are based on which day the instant meeting time falls for the instant campus. For example, if the meeting time falls on a weekend for the campus, or on a company official holiday for the country in which the campus is located, then a negative 10,000 point penalty is assessed; if the meeting falls on a Wednesday, then a negative 3 point penalty is assessed; and a variable negative point penalty P1 is assessed according to the following equation:

P1=(meeting start day−today)*1

Scoring rules 415D are campus specific scoring rules based on the time of day and the day of the week of a meeting. The example scoring rules 415D provided in block 414 are as follows. If the meeting starts before 10 am on the first day of the work week (e.g., Monday), then a negative penalty P2 is assessed based on the following equation:

P2=(10 am−meeting start time)̂2*16*4

If the meeting starts before 10 am on a day that is not the first day of the work week, then a negative penalty P2 is assessed based on the following equation:

P2=(10 am−meeting start time)̂2*16

If a meeting starts after 4:30 pm on the last day of the work week (e.g., Friday), then a negative penalty P3 may be assessed based on the following equation:

P3=(start time−4:30 pm)̂2*16*4

If a meeting starts after 4:30 pm on a day that is not the last day of the work week, then a negative penalty P3 may be assessed based on the following equation:

P3=(start time−4:30 pm)̂2*16*0.5

In an embodiment, scores may be generated to prioritize meeting times during working hours for all or some of the attendees.

The number of attendees associated with a campus under consideration, as opposed to other attendees associated with other campuses, is also factored into the score. For example, a resulting score 415E of all scores generated by the scoring rules 415A, 415B, 415C, and 414D may be calculated, and a cumulative score (S1) may be determined based on the following equation:

S1=(score 415E*number of attendees at this campus)/(number of attendees)

Cumulative score S1 is represented in FIG. 4 as cumulative score 415F.

A cumulative score from block 410 and block 414 is generated (e.g., by adding cumulative scores 411C and 415F), as represented by block 416. For each time interval under consideration, the process is then repeated if any additional campuses have not been scored, as represented by block 418 and arrow back to block 412. When the cumulative scores at block 416 have been generated for all campuses, all the cumulative scores generated from block 416 are sorted or ranked, as represented by block 420.

At block 422, meeting location information is obtained for scoring meeting locations based on various scoring rules. The information may be obtained by the data collection module 204 of FIG. 2 from the location data source 108 in FIG. 1. For example, campus maps may be obtained to determine the distance (e.g., walking distance) between attendee locations (e.g., attendee desk) and a meeting location (e.g., meeting room). In an embodiment, for each floor of a building, a score is generated based on the walking distance for attendees at the campus. In an embodiment, scores may be generated to prioritize meeting locations closest to the largest grouping of attendees. In an embodiment, scores may be generated to prioritize meeting locations that require the least aggregate amount of travel required by the attendees to attend the meeting location.

At block 424, the walk scores are sorted. For example, the walk score for each floor of a building is sorted. At block 426, meeting locations may be discarded or eliminated as potential meeting locations. For example, each meeting location may be checked for availability and room size, and any meeting location that is not available (e.g., already booked for the meeting time under consideration) or that is too small is eliminated as a potential meeting location.

At block 428, scores are generated based on various scoring rules for each meeting location that is not discarded in block 426. For example, scoring rule 429A is based on the distance attendees must travel, and generates a negative penalty P4 which may be assessed based on the following equation:

P4=(total distance/number of attendees at the campus)

Scoring rule 429B is based on rooms that are larger than needed, and generates a variable negative penalty which may be assessed based on a value within a range between 0 to 1.5, depending on how much larger than required the room is. Scoring rules 429C is based on the capabilities of a room and whether the meeting involves multiple campuses. Scoring rules 429C generates: a negative 0.5 point penalty if the room is enabled for virtual conferencing but the meeting does not involve multiple campuses; and a positive 2.5 point award if the room is enabled for virtual conferencing and the meeting involves multiple campuses.

At block 430, if another possible meeting time is left at the next time interval of the time period, then the scoring process is repeated, as represented by the arrow from block 430 to block 408. When meeting times at another time interval of the time period no longer remain, then a predetermined number of meeting time and location pairs with the highest scores are communicated to the meeting organizer (e.g., top 10 meeting time and location pairs), as represented by block 432. The meeting organizer may then select a final meeting time and location pair for each campus involved in the meeting. The final meeting time and location pair for each campus is then scheduled Scheduling invites may be sent to the attendees of the meeting request. For example, the selection module 208 of FIG. 2 may receive the final meeting time and location pairs and initiate the scheduling of the final meeting time and locations.

In another embodiment, blocks 408 through 418 are repeated for every time interval of the time period. After blocks 408 through 418 have been performed for every time interval of the time period, the cumulative scores generated from block 416 are ranked, and a predetermined number of the highest ranking meeting times are selected, such as the top 10 meeting times for instance. Then, blocks 422-428 may be performed for only these highest ranking meeting times, in order to find potential meeting locations for each of the meeting times. After block 428, for instance, the highest ranking meeting times may be selected with the highest scoring meeting locations for each meeting time.

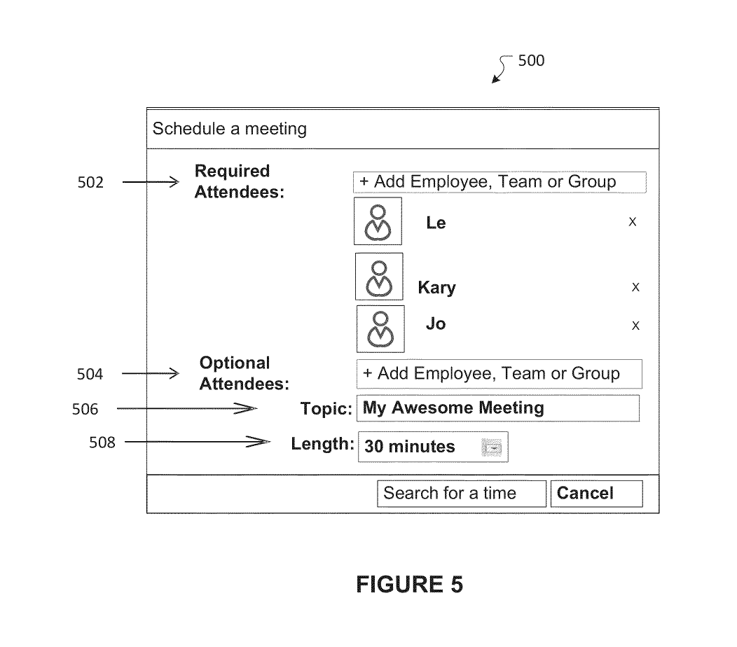

FIG. 5 illustrates a user interface for a meeting request, according to an embodiment of the present disclosure. User interface 500 includes various meeting parameters (e.g., required attendees 502, optional attendees 504, topic 506, and length of the meeting 508) which may be entered or otherwise selected by a meeting organizer for the meeting request. For example, the user interface 500 may be displayed on a user device to which the meeting organizer may provide the meeting parameters.

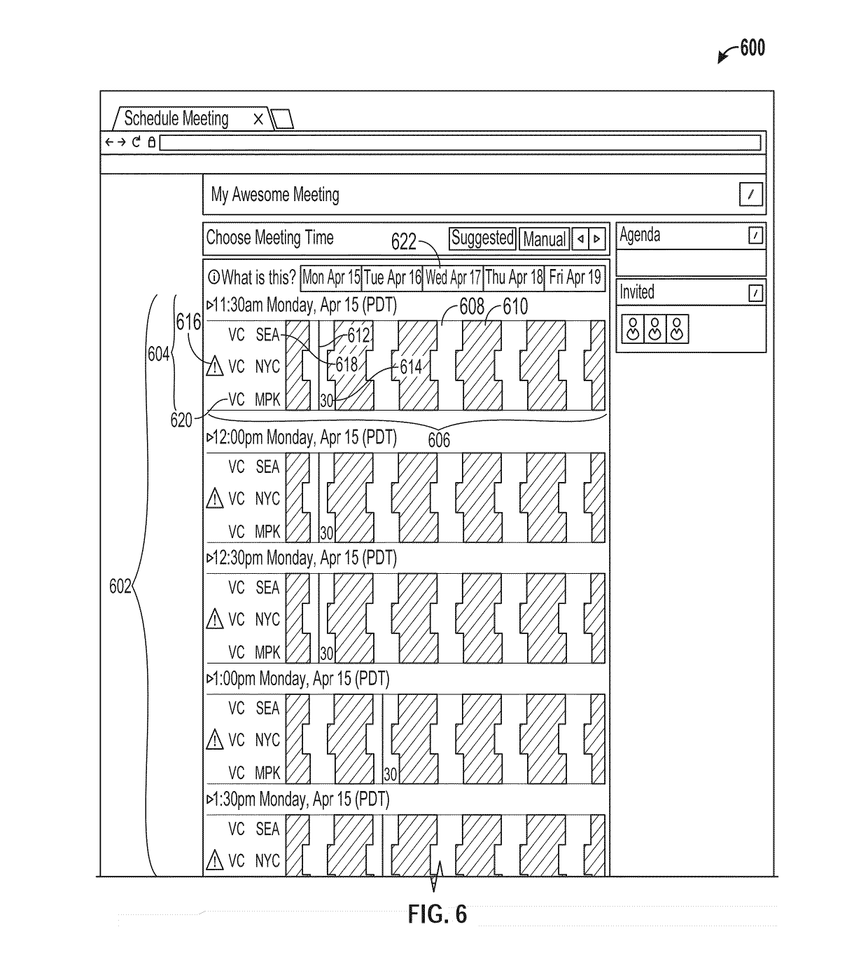

FIG. 6 illustrates a user interface displaying various potential meeting times that are selected and communicated to a meeting organizer in response to a meeting request, according to an embodiment of the present disclosure. User interface 600 includes potential meeting times 602 that were selected based on scores generated for various meeting times and locations. For example, a first potential meeting time 604 is at 11:30 am on Monday, April 15 Pacific Daylight Time.

The potential meeting time 604 includes a visual timeline representation 606 for each applicable campus 618 with one or more attendees—e.g., the Seattle (SEA) campus, the Menlo Park (MPK) campus, and the New York City (NYC) campus. The visual timeline representation 606 shows the working hours 608 (non-shaded) and non-working hours 610 (shaded) for each campus for the work week. Furthermore, the visual timeline representation 606 is normalized for the different time zones of each campus. For example, the timeline for the Seattle (SEA) campus is accordingly aligned with the timeline for the Menlo Park (MPK) campus because both are in the same time zone. However, the timeline for the New York City (NYC) campus is shifted from the Seattle and Menlo Park timelines based on the time zone difference. The visual timeline representation 606 may also include an indicator 612 for the meeting time. Because the visual timelines of each campus are normalized, the indicator 612 may be shown as a straight line through the three timelines of visual timeline representation 606. An indicator 614 of the length of meeting time is also displayed next to the indicator 612. The visual timeline representation 606 also includes an indicator 620 that indicates one or more attributes of the meeting—e.g., whether video conferencing is available at a campus. In an embodiment, the meeting scheduling system 100 automatically may determine that a certain capability (e.g., video conferencing) should be required or prioritized for a meeting based on meeting parameters (e.g., a meeting that will involve attendees over different campuses). As described herein in more detail, such required or prioritized capability may be reflected in scoring of the meeting location.

The visual timeline representation 606 also includes a warning indicator 616 that is associated with the potential meeting time 604 to indicate that one or more warnings are associated with the potential meeting time 604. The warnings may include, for example, one or more undesirable aspects of the meeting time. For instance, any aspect of a meeting that generates a penalty may be result in the warning indicator 616 (e.g., one or more required attendees are not available, a meeting falls outside normal working hours for one or more attendees, a room does not possess required capabilities for the meeting such as video conferencing capability for meetings involving multiple campuses, etc.). The meeting organizer may be able to click on the warning indicator 616, for instance, to find out further details about the warnings. In some instances, some or all of the potential meeting times that are selected and communicated to the meeting organizer may have one or more undesirable aspects, and accordingly may prompt warnings. In this way, even if no perfect meeting time and location pairs exist, at least some potential meeting times, notwithstanding their undesirable aspects, still can be selected and communicated to the meeting organizer.

The features of the visual timeline representation 606 described above for the potential meeting time 604 may be applicable to the other meeting times. Furthermore, it should be appreciated that the visual timeline representation 606 is exemplary and that other embodiments may not include one or more features of the visual representation, or may include additional features. Furthermore, various features of the visual representation may be user customizable, for example, to display a warning indicator 616 only for undesirable aspects that are user selected, or to display the indicator 620 for user selected attributes of the meeting.

In the embodiment shown, the potential meeting times 602 are shown for the current work week. For example, the time period for the meeting search (e.g., determined by the parameter determination module 202 in FIG. 2) may be predetermined or selected to search the current week, and accordingly the current week is displayed on the user interface 600. In other embodiments, a different time period may be set as the default setting or user selected setting.

The user interface 600 also includes an indicator 622 for every day within the shown work week. The indicator 622 is accordingly aligned with the visual timeline representation 606. In an embodiment, the user interface 600 may allow a user to select a day of the week (e.g., via the indicator 622) in which to rerun a meeting search for a new time period. For example, a meeting organizer may click on the indicator 622 for Wednesday, April 17, and a new search may be executed accordingly. For example, in the example shown in FIG. 4, a new search would be performed at block 404 using the meeting parameters of the meeting request from block 402. At block 404, the time period (e.g., “current week”) would be replaced with the time period for one day (e.g., Wednesday, April 17), and the process 400 would continue. After the process 400 is performed, a user interface similar to user interface 600 would be displayed, except that the visual timeline representation would be for a single day (e.g., Wednesday, April 17).

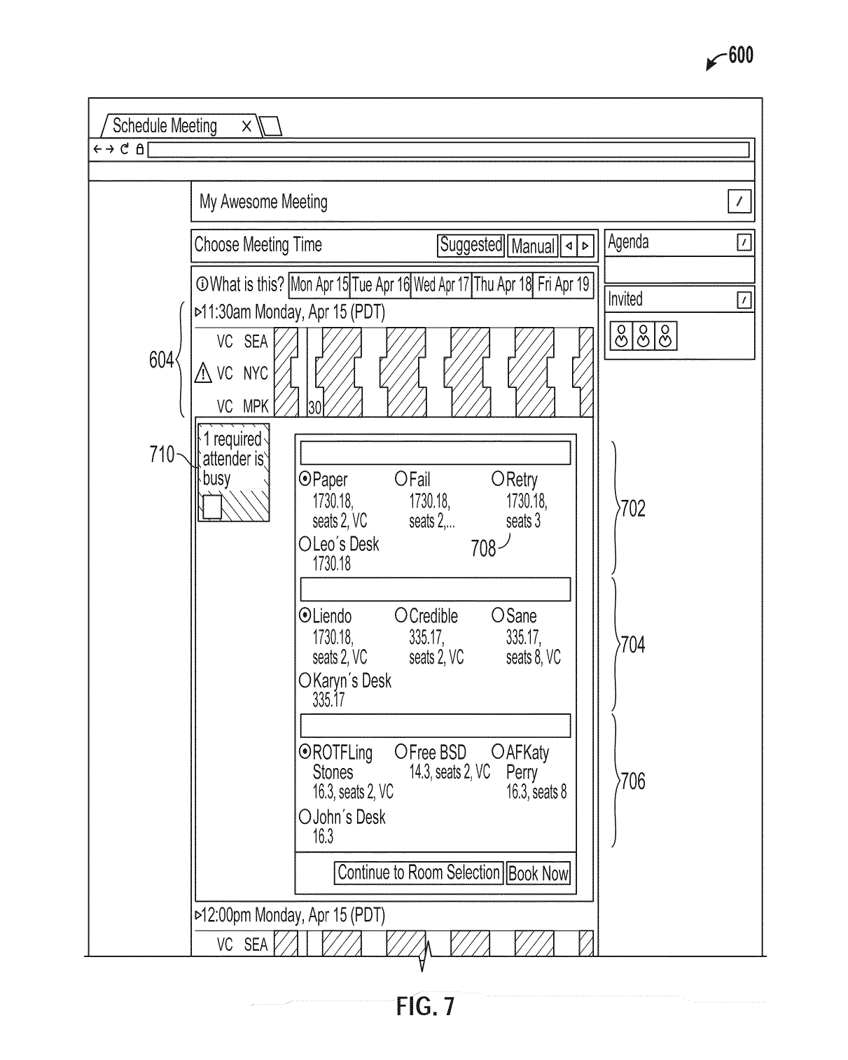

When presented with the potential meeting times 602 of the user interface 600, the meeting organizer may decide on a specific meeting time and select it (e.g., clicking on the corresponding visual representation for the potential meeting time). The user interface 600 then may present the meeting organizer with potential meeting locations for the specific meeting time that the meeting organizer has selected. FIG. 7 illustrates the user interface 600 showing potential meeting locations for a specific meeting time chosen by a meeting organizer, according to an embodiment of the present disclosure. Specifically, the user interface 600 shows the potential meeting locations after the meeting organizer selects the potential meeting time 604 shown in FIG. 6. The user interface 600 includes potential meeting locations 702 for the Seattle campus, potential meeting locations 704 for the New York campus, and potential meeting locations 706 for the Menlo Park campus. The user interface 600 may enable the meeting organizer to select any of the displayed potential meeting locations for each campus. For example, the potential meeting locations 702 include 4 meeting locations for the meeting organizer to choose from. Each of the four meeting location may indicate various attributes for the specific meeting location. For example, attributes 708 include the meeting location (e.g., room number), name of the meeting location, capacity of the meeting location (e.g., seating capacity), and capability of the meeting location (e.g., video conferencing enabled). Other attributes may be shown in other embodiments. In an embodiment, the attributes 708 that may be displayed are user selectable or customizable. Additional warning details 710 (e.g., a required attendee is busy) also may be shown for the potential meeting 604 and the currently marked configuration of the potential meeting locations 702, 704, and 706.

After the meeting organizer selects the desired meeting locations 702, 704, and 706 for each campus, the final meeting time and location pairs (i.e., for each campus) are scheduled, and scheduling invites may be sent to the attendees of the meeting request. For example, the selection module 208 of FIG. 2 may receive the final meeting time and location pairs and initiate the scheduling of the final meeting time and locations. In an embodiment, the final meeting time and location pairs may be automatically selected by the meeting scheduling system 100 subject to confirmation by the meeting organizer.

### Social Networking System

### Example Implementation

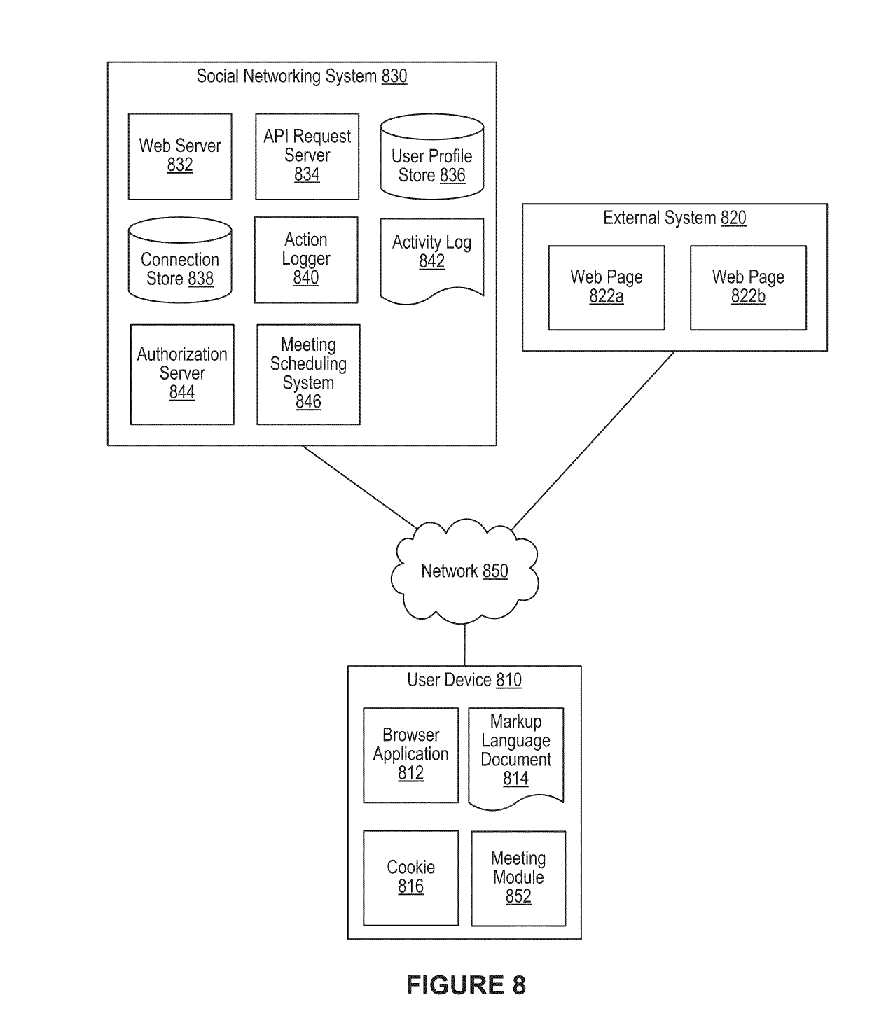

FIG. 8 is a network diagram of an example system 800 for selecting potential meeting time and location pairs in response to a meeting request, in accordance with an embodiment of the invention. The system 800 includes one or more user devices 810, one or more external systems 820, a social networking system 830, and a network 850. In an embodiment, the meeting scheduling system 100 discussed herein may be implemented within the social networking system 830. For purposes of illustration, the embodiment of the system 800, shown by FIG. 8, includes a single external system 820 and a single user device 810. However, in other embodiments, the system 800 may include more user devices 810 and/or more external systems 820. In certain embodiments, the social networking system 830 is operated by a social network provider, whereas the external systems 820 are separate from the social networking system 830 in that they may be operated by different entities. In various embodiments, however, the social networking system 830 and the external systems 820 operate in conjunction to provide social networking services to users (or members) of the social networking system 830. In this sense, the social networking system 830 provides a platform or backbone, which other systems, such as external systems 820, may use to provide social networking services and functionalities to users across the Internet.

The user device 810 comprises one or more computing devices that can receive input from a user and transmit and receive data via the network 850. In one embodiment, the user device 810 is a conventional computer system executing, for example, a Microsoft Windows compatible operating system (OS), Apple OS X, and/or a Linux distribution. In another embodiment, the user device 810 can be a device having computer functionality, such as a smart-phone, a tablet, a personal digital assistant (PDA), a mobile telephone, etc. The user device 810 is configured to communicate via the network 850. The user device 810 can execute an application, for example, a browser application that allows a user of the user device 810 to interact with the social networking system 830. In another embodiment, the user device 810 interacts with the social networking system 830 through an application programming interface (API) provided by the native operating system of the user device 810, such as iOS and ANDROID. The user device 810 is configured to communicate with the external system 820 and the social networking system 830 via the network 850, which may comprise any combination of local area and/or wide area networks, using wired and/or wireless communication systems.

In one embodiment, the network 850 uses standard communications technologies and protocols. Thus, the network 850 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 850 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 850 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 810 may display content from the external system 820 and/or from the social networking system 830 by processing a markup language document 814 received from the external system 820 and from the social networking system 830 using a browser application 812. The markup language document 814 identifies content and one or more instructions describing formatting or presentation of the content. By executing the instructions included in the markup language document 814, the browser application 812 displays the identified content using the format or presentation described by the markup language document 814. For example, the markup language document 814 includes instructions for generating and displaying a web page having multiple frames that include text and/or image data retrieved from the external system 820 and the social networking system 830. In various embodiments, the markup language document 814 comprises a data file including extensible markup language (XML) data, extensible hypertext markup language (XHTML) data, or other markup language data. Additionally, the markup language document 814 may include JavaScript Object Notation (JSON) data, JSON with padding (JSONP), and JavaScript data to facilitate data-interchange between the external system 820 and the user device 810. The browser application 812 on the user device 810 may use a JavaScript compiler to decode the markup language document 814.

The markup language document 814 may also include, or link to, applications or application frameworks such as FLASH™ or Unity™ applications, the SilverLight™ application framework, etc.

In one embodiment, the user device 810 also includes one or more cookies 816 including data indicating whether a user of the user device 810 is logged into the social networking system 830, which may enable modification of the data communicated from the social networking system 830 to the user device 810.

The user device 810 may also include a meeting module 852 that enables a meeting request to be generated on the user device 810. In an embodiment, the user interface of FIG. 5 may be generated by the meeting module 852 and displayed on the user device 810. Furthermore, the meeting module 852 may generate the appropriate user interfaces that display the potential meeting times and locations to the meeting organizer. For example, in an embodiment, the meeting module 852 may be used to generate the user interface 600 of FIGS. 6 and 7 on the user device 810.

The external system 820 includes one or more web servers that include one or more web pages 822a, 822b, which are communicated to the user device 810 using the network 850. The external system 820 is separate from the social networking system 830. For example, the external system 820 is associated with a first domain, while the social networking system 830 is associated with a separate social networking domain. Web pages 822a, 822b, included in the external system 820, comprise markup language documents 814 identifying content and including instructions specifying formatting or presentation of the identified content.

The social networking system 830 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 830 may be administered, managed, or controlled by an operator. The operator of the social networking system 830 may be a human being, an automated application, or a series of applications for managing content, regulating policies, and collecting usage metrics within the social networking system 830. Any type of operator may be used.

Users may join the social networking system 830 and then add connections to any number of other users of the social networking system 830 to whom they desire to be connected. As used herein, the term “friend” refers to any other user of the social networking system 830 to whom a user has formed a connection, association, or relationship via the social networking system 830. For example, in an embodiment, if users in the social networking system 830 are represented as nodes in the social graph, the term “friend” can refer to an edge formed between and directly connecting two user nodes.

Connections may be added explicitly by a user or may be automatically created by the social networking system 830 based on common characteristics of the users (e.g., users who are alumni of the same educational institution). For example, a first user specifically selects a particular other user to be a friend. Connections in the social networking system 830 are usually in both directions, but need not be, so the terms “user” and “friend” depend on the frame of reference. Connections between users of the social networking system 830 are usually bilateral (“two-way”), or “mutual,” but connections may also be unilateral, or “one-way.” For example, if Bob and Joe are both users of the social networking system 830 and connected to each other, Bob and Joe are each other's connections. If, on the other hand, Bob wishes to connect to Joe to view data communicated to the social networking system 830 by Joe, but Joe does not wish to form a mutual connection, a unilateral connection may be established. The connection between users may be a direct connection; however, some embodiments of the social networking system 830 allow the connection to be indirect via one or more levels of connections or degrees of separation.

In addition to establishing and maintaining connections between users and allowing interactions between users, the social networking system 830 provides users with the ability to take actions on various types of items supported by the social networking system 830. These items may include groups or networks (i.e., social networks of people, entities, and concepts) to which users of the social networking system 830 may belong, events or calendar entries in which a user might be interested, computer-based applications that a user may use via the social networking system 830, transactions that allow users to buy or sell items via services provided by or through the social networking system 830, and interactions with advertisements that a user may perform on or off the social networking system 830. These are just a few examples of the items upon which a user may act on the social networking system 830, and many others are possible. A user may interact with anything that is capable of being represented in the social networking system 830 or in the external system 820, separate from the social networking system 830, or coupled to the social networking system 830 via the network 850.

The social networking system 830 is also capable of linking a variety of entities. For example, the social networking system 830 enables users to interact with each other as well as external systems 820 or other entities through an API, a web service, or other communication channels. The social networking system 830 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 830. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 830 modifies edges connecting the various nodes to reflect the relationships and interactions.

The social networking system 830 also includes user-generated content, which enhances a user's interactions with the social networking system 830. User-generated content may include anything a user can add, upload, send, or “post” to the social networking system 830. For example, a user communicates posts to the social networking system 830 from a user device 810. Posts may include data such as status updates or other textual data, location information, images such as photos, videos, links, music or other similar data and/or media. Content may also be added to the social networking system 830 by a third party. Content “items” are represented as objects in the social networking system 830. In this way, users of the social networking system 830 are encouraged to communicate with each other by posting text and content items of various types of media through various communication channels. Such communication increases the interaction of users with each other and increases the frequency with which users interact with the social networking system 830.

The social networking system 830 includes a web server 832, an API request server 834, a user profile store 836, a connection store 838, an action logger 840, an activity log 842, an authorization server 844, and a video substitution module 846. In an embodiment of the invention, the social networking system 830 may include additional, fewer, or different components for various applications. Other components, such as network interfaces, security mechanisms, load balancers, failover servers, management and network operations consoles, and the like are not shown so as to not obscure the details of the system.

The user profile store 836 maintains information about user accounts, including biographic, demographic, and other types of descriptive information, such as work experience, educational history, hobbies or preferences, location, and the like that has been declared by users or inferred by the social networking system 830. This information is stored in the user profile store 836 such that each user is uniquely identified. The social networking system 830 also stores data describing one or more connections between different users in the connection store 838. The connection information may indicate users who have similar or common work experience, group memberships, hobbies, or educational history. Additionally, the social networking system 830 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 830, such as non-person entities, buckets, cluster centers, images, interests, pages, external systems, concepts, and the like are also stored in the connection store 838.

The social networking system 830 maintains data about objects with which a user may interact. To maintain this data, the user profile store 836 and the connection store 838 store instances of the corresponding type of objects maintained by the social networking system 830. Each object type has information fields that are suitable for storing information appropriate to the type of object. For example, the user profile store 836 contains data structures with fields suitable for describing a user's account and information related to a user's account. When a new object of a particular type is created, the social networking system 830 initializes a new data structure of the corresponding type, assigns a unique object identifier to it, and begins to add data to the object as needed. This might occur, for example, when a user becomes a user of the social networking system 830, the social networking system 830 generates a new instance of a user profile in the user profile store 836, assigns a unique identifier to the user account, and begins to populate the fields of the user account with information provided by the user.

The connection store 838 includes data structures suitable for describing a user's connections to other users, connections to external systems 820 or connections to other entities. The connection store 838 may also associate a connection type with a user's connections, which may be used in conjunction with the user's privacy setting to regulate access to information about the user. In an embodiment of the invention, the user profile store 836 and the connection store 838 may be implemented as a federated database.

Data stored in the connection store 838, the user profile store 836, and the activity log 842 enables the social networking system 830 to generate the social graph that uses nodes to identify various objects and edges connecting nodes to identify relationships between different objects. For example, if a first user establishes a connection with a second user in the social networking system 830, user accounts of the first user and the second user from the user profile store 836 may act as nodes in the social graph. The connection between the first user and the second user stored by the connection store 838 is an edge between the nodes associated with the first user and the second user. Continuing this example, the second user may then send the first user a message within the social networking system 830. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 830 (or, alternatively, in an image maintained by another system outside of the social networking system 830). The image may itself be represented as a node in the social networking system 830. This tagging action may create edges between the first user and the second user as well as create an edge between each of the users and the image, which is also a node in the social graph. In yet another example, if a user confirms attending an event, the user and the event are nodes obtained from the user profile store 836, where the attendance of the event is an edge between the nodes that may be retrieved from the activity log 842. By generating and maintaining the social graph, the social networking system 830 includes data describing many different types of objects and the interactions and connections among those objects, providing a rich source of socially relevant information.

The web server 832 links the social networking system 830 to one or more user devices 810 and/or one or more external systems 820 via the network 850. The web server 832 serves web pages, as well as other web-related content, such as Java, JavaScript, Flash, XML, and so forth. The web server 832 may include a mail server or other messaging functionality for receiving and routing messages between the social networking system 830 and one or more user devices 810. The messages can be instant messages, queued messages (e.g., email), text and SMS messages, or any other suitable messaging format.

The API request server 834 allows one or more external systems 820 and user devices 810 to call access information from the social networking system 830 by calling one or more API functions. The API request server 834 may also allow external systems 820 to send information to the social networking system 830 by calling APIs. The external system 820, in one embodiment, sends an API request to the social networking system 830 via the network 850, and the API request server 834 receives the API request. The API request server 834 processes the request by calling an API associated with the API request to generate an appropriate response, which the API request server 834 communicates to the external system 820 via the network 850. For example, responsive to an API request, the API request server 834 collects data associated with a user, such as the user's connections that have logged into the external system 820, and communicates the collected data to the external system 820. In another embodiment, the user device 810 communicates with the social networking system 830 via APIs in the same manner as external systems 820.

The action logger 840 is capable of receiving communications from the web server 832 about user actions on and/or off the social networking system 830. The action logger 840 populates the activity log 842 with information about user actions, enabling the social networking system 830 to discover various actions taken by its users within the social networking system 830 and outside of the social networking system 830. Any action that a particular user takes with respect to another node on the social networking system 830 may be associated with each user's account, through information maintained in the activity log 842 or in a similar database or other data repository. Examples of actions taken by a user within the social networking system 830 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 830, the action is recorded in the activity log 842. In one embodiment, the social networking system 830 maintains the activity log 842 as a database of entries. When an action is taken within the social networking system 830, an entry for the action is added to the activity log 842. The activity log 842 may be referred to as an action log.

Additionally, user actions may be associated with concepts and actions that occur within an entity outside of the social networking system 830, such as an external system 820 that is separate from the social networking system 830. For example, the action logger 840 may receive data describing a user's interaction with an external system 820 from the web server 832. In this example, the external system 820 reports a user's interaction according to structured actions and objects in the social graph.

Other examples of actions where a user interacts with an external system 820 include a user expressing an interest in an external system 820 or another entity, a user posting a comment to the social networking system 830 that discusses an external system 820 or a web page 822a within the external system 820, a user posting to the social networking system 830 a Uniform Resource Locator (URL) or other identifier associated with an external system 820, a user attending an event associated with an external system 820, or any other action by a user that is related to an external system 820. Thus, the activity log 842 may include actions describing interactions between a user of the social networking system 830 and an external system 820 that is separate from the social networking system 830.

The authorization server 844 enforces one or more privacy settings of the users of the social networking system 830. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 820, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 820. One embodiment allows the specification of the set of entities to comprise an enumeration of entities. For example, the user may provide a list of external systems 820 that are allowed to access certain information. Another embodiment allows the specification to comprise a set of entities along with exceptions that are not allowed to access the information. For example, a user may allow all external systems 820 to access the user's work information, but specify a list of external systems 820 that are not allowed to access the work information. Certain embodiments call the list of exceptions that are not allowed to access certain information a “block list”. External systems 820 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 844 contains logic to determine if certain information associated with a user can be accessed by a user's friends, external systems 820, and/or other applications and entities. The external system 820 may need authorization from the authorization server 844 to access the user's more private and sensitive information, such as the user's work phone number. Based on the user's privacy settings, the authorization server 844 determines if another user, the external system 820, an application, or another entity is allowed to access information associated with the user, including information about actions taken by the user.

According to an embodiment of the invention, the social networking system 830 may include a meeting scheduling system 846. In an embodiment, the meeting scheduling system 846 may be implemented as the meeting scheduling system 100. The meeting scheduling system 846 may, for example, control the calendaring system for the users within the social networking system, and select potential meeting time and location pairs based on scoring rules for users that request a meeting, as described herein.

### Hardware Implementation

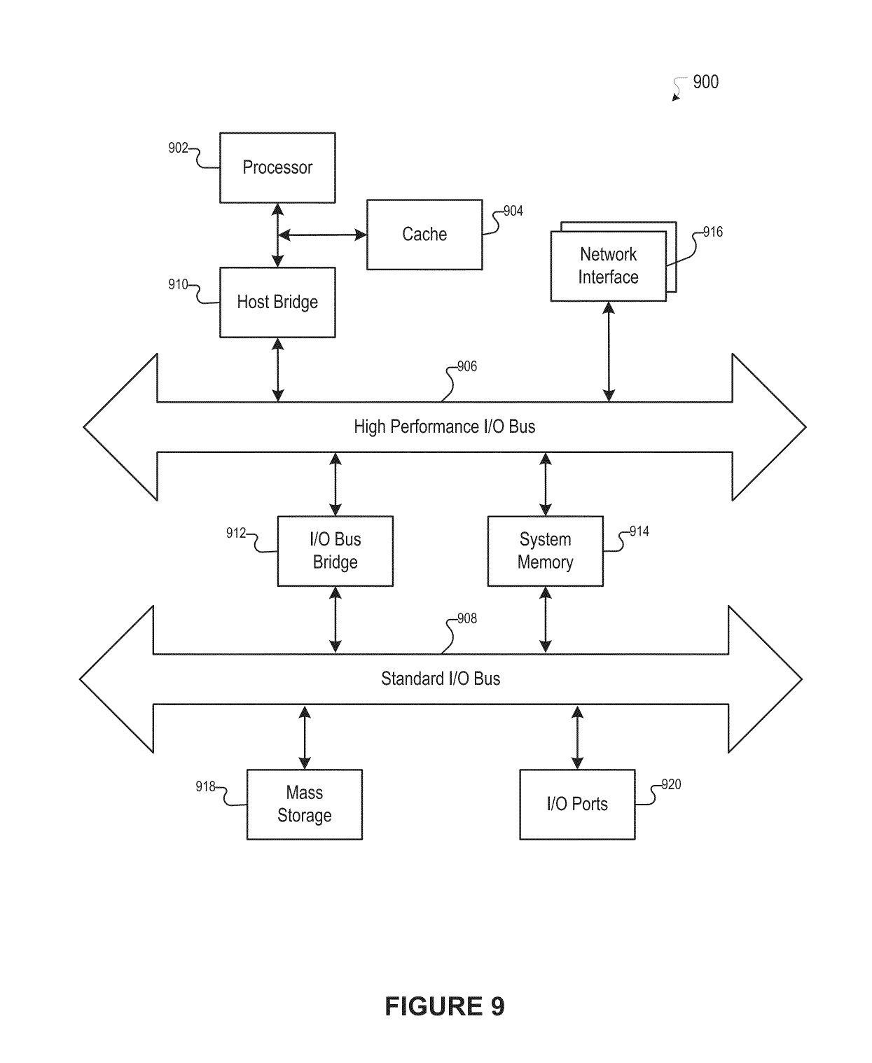

The foregoing processes and features can be implemented by a wide variety of machine and computer system architectures and in a wide variety of network and computing environments. FIG. 9 illustrates an example of a computer system 900 that may be used to implement one or more of the embodiments described herein in accordance with an embodiment of the invention. The computer system 900 includes sets of instructions for causing the computer system 900 to perform the processes and features discussed herein. The computer system 900 may be connected (e.g., networked) to other machines. In a networked deployment, the computer system 900 may operate in the capacity of a server machine or a client machine in a client-server network environment, or as a peer machine in a peer-to-peer (or distributed) network environment. In an embodiment of the invention, the computer system 900 may be the social networking system 830, the user device 810, and the external system 820, or a component thereof. In an embodiment of the invention, the computer system 900 may be one server among many that constitutes all or part of the social networking system 830.

The computer system 900 includes a processor 902, a cache 904, and one or more executable modules and drivers, stored on a computer-readable medium, directed to the processes and features described herein. Additionally, the computer system 900 includes a high performance input/output (I/O) bus 906 and a standard I/O bus 908. A host bridge 910 couples processor 902 to high performance I/O bus 906, whereas I/O bus bridge 912 couples the two buses 906 and 908 to each other. A system memory 914 and one or more network interfaces 916 couple to high performance I/O bus 906. The computer system 900 may further include video memory and a display device coupled to the video memory (not shown). Mass storage 918 and I/O ports 920 couple to the standard I/O bus 908. The computer system 900 may optionally include a keyboard and pointing device, a display device, or other input/output devices (not shown) coupled to the standard I/O bus 908. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 900, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 900 are described in greater detail below. In particular, the network interface 916 provides communication between the computer system 900 and any of a wide range of networks, such as an Ethernet (e.g., IEEE 802.3) network, a backplane, etc. The mass storage 918 provides permanent storage for the data and programming instructions to perform the above-described processes and features implemented by the respective computing systems identified above, whereas the system memory 914 (e.g., DRAM) provides temporary storage for the data and programming instructions when executed by the processor 902. The I/O ports 920 may be one or more serial and/or parallel communication ports that provide communication between additional peripheral devices, which may be coupled to the computer system 900.

The computer system 900 may include a variety of system architectures, and various components of the computer system 900 may be rearranged. For example, the cache 904 may be on-chip with processor 902. Alternatively, the cache 904 and the processor 902 may be packed together as a “processor module”, with processor 902 being referred to as the “processor core”. Furthermore, certain embodiments of the invention may neither require nor include all of the above components. For example, peripheral devices coupled to the standard I/O bus 908 may couple to the high performance I/O bus 906. In addition, in some embodiments, only a single bus may exist, with the components of the computer system 900 being coupled to the single bus. Furthermore, the computer system 900 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 900 that, when read and executed by one or more processors, cause the computer system 900 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 900, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 902. Initially, the series of instructions may be stored on a storage device, such as the mass storage 918. However, the series of instructions can be stored on any suitable computer readable storage medium. Furthermore, the series of instructions need not be stored locally, and could be received from a remote storage device, such as a server on a network, via the network interface 916. The instructions are copied from the storage device, such as the mass storage 918, into the system memory 914 and then accessed and executed by the processor 902. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 900 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed:

1. A computer implemented method comprising:
determining, by a computer system, meeting parameters for a meeting request;
generating, by the computer system, scores for each of a plurality of meeting times based on the meeting parameters;
generating, by the computer system, scores for each of a plurality of meeting locations based on the meeting parameters; and
selecting, by the computer system, one or more potential meeting time and meeting location pairs based on the scores for each of the plurality of meeting times and the scores for each of the plurality of meeting locations.

2. The computer implemented method of claim 1, wherein at least one potential meeting time and meeting location pair is selected for each campus of a plurality of campuses associated with the meeting request.

3. The computer implemented method of claim 2, wherein the plurality of campuses is in different time zones.

4. The computer implemented method of claim 1, wherein at least one of the scores for each of the plurality of meeting times and the scores for each of the plurality of meeting locations is based on point deductions associated with penalties.

5. The computer implemented method of claim 1, wherein the generating scores for each of the plurality of meeting times is based at least in part on attendee availability or status.

6. The computer implemented method of claim 1, wherein the generating scores for each of the plurality of meeting times is based at least in part on optimization of schedules of attendees.

7. The computer implemented method of claim 1, wherein the generating scores for each of the plurality of meeting times is based at least in part on whether the meeting times fall on a weekend.

8. The computer implemented method of claim 1, wherein the generating scores for each of the plurality of meeting times is based at least in part on whether the meeting times fall within a predetermined time range within a work day.

9. The computer implemented method of claim 1, wherein the generating scores for each of the plurality of meeting locations is based at least in part on a distance between an attendee location and a meeting location.

10. The computer implemented method of claim 1, wherein the generating scores for each of the plurality of meeting times is based at least in part on whether the meeting times fall on a company official holiday for a country where an attendee is located.

11. The computer implemented method of claim 1, wherein the generating scores for each of the plurality of meeting locations is based at least in part on a room size or on available equipment for a meeting location.

12. The computer implemented method of claim 1, wherein the generating scores for each of the plurality of meeting locations is based at least in part on video conferencing availability at a meeting location.

13. The computer implemented method of claim 1, wherein the meeting parameters comprise a length of time for a meeting.

14. The computer implemented method of claim 1, wherein the meeting parameters comprise information about required attendees and optional attendees.

15. The computer implemented method of claim 1, further comprising:
determining a time period and a time interval to identify a meeting time;
wherein the generating scores for each of the plurality of meeting times is performed for all time intervals within the time period.

16. The computer implemented method of claim 1, further comprising:
communicating the one or more potential meeting times and meeting locations to a user device associated with a meeting organizer.

17. The computer implemented method of claim 16, further comprising:
receiving an indication of a selection of a final meeting time and meeting location by the meeting organizer; and
initiating a scheduling event for the final meeting time and meeting location.

18. The computer implemented method of claim 1, wherein schedule data is unavailable for at least one attendee associated with the meeting request.

19. A system comprising:
at least one processor; and
a memory storing instructions configured to instruct the at least one processor to perform:
determine meeting parameters for a meeting request;
generate scores for each of a plurality of meeting times based on the meeting parameters;
generate scores for each of a plurality of meeting locations based on the meeting parameters; and
generate one or more potential meeting time and meeting location pairs based on the scores for each of the plurality of meeting times and the scores for each of the plurality of meeting locations.

20. A computer storage medium storing computer-executable instructions that, when executed, cause a computer system to perform a computer-implemented method comprising:
determining meeting parameters for a meeting request;
generating scores for each of a plurality of meeting times based on the meeting parameters;
generating scores for each of a plurality of meeting locations based on the meeting parameters; and
generating one or more potential meeting time and meeting location pairs based on the scores for each of the plurality of meeting times and the scores for each of the plurality of meeting locations.
